(19) United States
(12) Patent Application Publication
(10) Pub. No.: US 2010/0038347 A1
(43) Pub. Date: Feb. 18, 2010

(54) Method for controlling a laser body shell welding system, and laser body shell welding system

(76) Inventors: Tobias Schwarz, Bad Koenig (DE); Michael Janssen, Michelstadt (DE); Gerhard Duerr, Hoechst (DE); Ullrich Mueller, Michelstadt (DE); Peter Dinkelacker, Boeblingen (DE); Bioern Grimm, Aidlingen (DE); Thomas Kolb, Holzheim (DE); Mike Paelmer, Well der Stadt (DE); Thomas Stahs, Ulm (DE)

Correspondence Address: Striker, Striker & Stenby, 103 East Neck Road, Huntington, NY, 11743, US

(21) Appl. No.: 12/582,761

(22) Filed: Oct. 21, 2009

Related U.S. Application Data
(63) Continuation of application No. 11/838,558, filed on Aug. 14, 2007.

(30) Foreign Application Priority Data
Aug. 22, 2006 (DE) 10 2006 039 356.2

(51) Int. Cl. B23K 26/04; B23K 26/20; G06F 17/00

(52) U.S. Cl. 219/121.64; 219/121.81; 219/121.83; 700/166

(57) ABSTRACT

In a method for controlling a laser body shell welding system, in which a scanning head is attached to a machine arm or is operated as an external tool of the machine arm, the scanning head having at least one scanning mirror for positioning a laser beam on a workpiece to be welded, and the operation of the laser welding system including time-critical functions for controlling the time-critical functions, an embedded control system or a memory-programmable control system is used.

### CROSS-REFERENCE TO A RELATED APPLICATION

The invention described and claimed hereinbelow is also described in German Patent Application DE 10 2006 039 356.2 filed on Aug. 22, 2006. This German Patent Application, whose subject matter is incorporated here by reference, provides the basis for a claim of priority of invention under 35 U.S.C. 119(a)-(d).

### BACKGROUND OF THE INVENTION

The invention relates to a method for controlling a laser body shell welding system and to a laser body shell welding system.

In body shell construction, laser welding methods and systems have recently been employed, by means of which body parts can be put together faster and more flexibly than with the previously used resistance spot welding method. For performing this in terms of technology, multiaxial industrial robots are equipped with laser welding systems. The robot arm is provided with an optical scanning head that controls the fine motion of the laser beam. The scanning head typically includes electronically controlled tilting mirrors (so-called scanning mirrors), which aim the laser beam at the welding spot.

With the robot, the rough path of motion over the workpiece or of the workpiece is defined, while conversely the exact positioning of the laser beam on the workpiece is done by the scanning head or the scanning mirrors.

In the known systems, a standard PC is provided for control. The complex cooperation of laser beam power, robot motion, and scanning head motion is regulated by control software that runs on a Windows operating system. The robot is typically connected to the PC via a standard network card. This has the disadvantage that the real-time capability of the system is difficult to assure. Time-critical functions must be optimized, which is very complicated, in order to furnish an acceptable running time. For expansion of the system, an intervention into the software is necessary.

### SUMMARY OF THE INVENTION

The object accordingly presents itself of enabling stable operation of time-critical components, especially the communication with the robot and the calculation of the mirror triggering from the path of motion, as well as expandability with control functions, using means in control technology.

In keeping with these objects and with others which will become apparent hereinafter, one feature of the present invention resides, briefly stated, in a method for controlling a laser body shell welding system, in which a scanning head is attached to a machine arm or is operated as an external tool of the machine arm, the scanning head having at least one scanning mirror for positioning a laser beam on a workpiece to be welded, and an operation of the laser welding system includes time-critical functions, the method comprising the steps of controlling the time-critical functions; and using for the controlling of the time-critical functions a system selected from the group consisting of an embedded control system, and a memory-programmable control system.

Another feature of the present invention resides, briefly stated, in a laser body shell welding system, comprising a scanning head attached to a machine arm or operated as an external tool of the machine arm, said scanning head including at least one scanning mirror for positioning a laser beam on a workpiece to be welded, wherein an operation of the laser welding system includes time-critical functions; and means for controlling the time-critical functions selected from the group consisting of an embedded control system and a memory-programmable control system.

According to the invention, in a laser body shell welding system, in which a scanning head is attached to a machine arm or operated as an external tool of the machine arm (robot), known as “steady-state operation” of the scanning head, in which the scanning head has at least one scanning mirror for positioning a laser beam on a workpiece to be welded, and the operation of the laser welding system includes both time-critical and non-time-critical functions, an embedded control system or an MPS system is used or provided for controlling time-critical functions. Non-time-critical functions, such as programming the control system and the observation or user control of the welding operation can continue to be performed on a conventional PC.

A memory-programmable control (MPS) is an electronic component unit that is employed in automation technology for control and regulation tasks. It has specialized input and output interfaces, to which sensors and actuators can be connected. The MPS (with its outputs) controls the input data of the time-critical functions and is programmable for that purpose. The programmability permits its use in the most various environments, which enhances its flexibility. The use of memory-programmable controls (the term in the industrial sense) does not necessarily mean that from the standpoint of regulating technology only control is done. The MPS can certainly take on regulation functions, or in other words can be part of feedback means.

An embedded computer system as a rule comprises both hardware and software. The software on such a system is known as firmware and is typically located in a ROM (read-only memory), which is embodied for instance as flash ROM. An embedded system also has RAM (random access memory), which includes dynamic data and is typically embodied as static RAM. In comparison to conventional computer systems, embedded systems are better suited to time-critical applications.

With the provisions according to the invention, the real-time capability of the time-critical functions can be assured in a simple way. The time-critical components are partitioned off, making it possible to assure stable operation. Information that occurs in the system can be transmitted via an MPS functionality to higher-order systems and be processed or prepared there. Finally, control programs for MPS control systems or embedded systems can be parametrized better and more simply, and conventional programming and user control surfaces in control technology can be employed.

It is expedient if, as the time-critical function, the at least one scanning mirror or its triggering is controlled. Particularly the aiming of the laser beam at the workpiece is an especially time-critical function, since in this case a plurality of parameters, and in particular those named below, cooperate. The use of an MPS control or an embedded system therefore has an especially advantageous effect on the system when the at least one scanning mirror is controlled.

Advantageously, as the time-critical function, a power of the laser beam is controlled. The laser beam power is also an especially time-critical function. The power must be regulated such that it reaches the predetermined value precisely whenever the laser beam is positioned at the predetermined welding spot. If delays occur, the welding power may for instance not suffice to join the components together. This can cause major safety-related defects in a motor vehicle, which can be avoided with the preferred embodiment of the invention.

It is equally advantageous if a fastening mechanism is controlled as the time-critical function. A fastening mechanism is provided for placing the parts that are to be joined for making the welding spot against one another without gaps, ready for the welding operation. Once again, this is a time-critical function, since the components to be joined must be fastened together early enough to allow a welding operation to be concluded successfully. Delays in clamping can also lead to safety-related defects.

Preferably, the machine arm is controlled as the time-critical function. The machine arm is provided for the coarse aiming of the scanning head over the workpiece, or of the workpieces, to be joined. Once again, it is therefore a time-critical function that can profit particularly from the provision according to the invention. The machine arm is preferably a six-axis industrial robot.

Preferably, an observation/reconstruction of the motion of the machine arm is implemented as a time-critical function. In particular, as the time-critical function, an observer of the machine arm is implemented, that reconstructs the path of motion of the machine arm from machine arm actual positions (so-called tool center points) transmitted in a fixed time matrix.

Further advantages and features of the invention will become apparent from the description and the accompanying drawings. It is understood that the characteristics mentioned above and to be explained hereinafter can be used not only in whatever combination stated, but in other combinations or on their own as well, without departing from the scope of the present invention.

The invention is shown schematically in the drawings in terms of one exemplary embodiment and will be described in detail hereinafter in conjunction with the drawings.

### BRIEF DESCRIPTION OF THE DRAWINGS

FIG. 1 schematically shows a first preferred embodiment of a laser body shell welding system in accordance with the present invention; and

FIG. 2 schematically shows a further preferred embodiment of a laser body shell welding system in accordance with the present invention.

### DESCRIPTION OF THE PREFERRED EMBODIMENTS

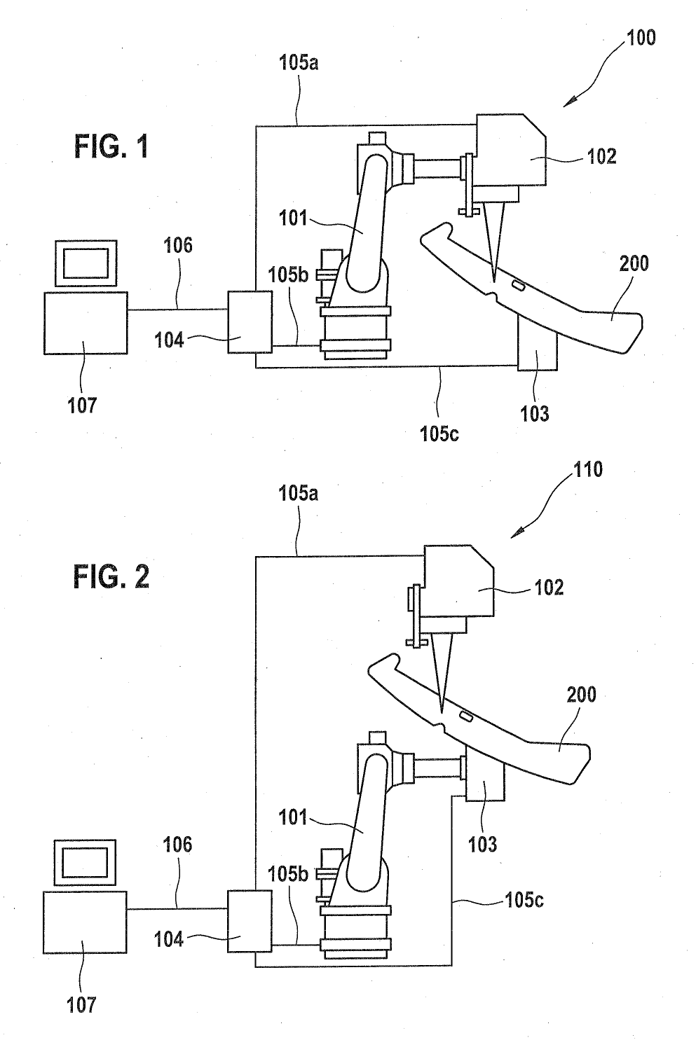

In FIG. 1, a first preferred embodiment of a laser body shell welding system (hereinafter called “system”) according to the invention is shown schematically and identified overall by reference numeral 100. The system 100 has a machine arm embodied as a six-axis industrial robot 101. A scanning head 102 is located on the end of the industrial robot 101.

The scanning head 102 has a laser source (not shown) and scanning mirrors (not shown) for positioning a laser beam on a workpiece 200. It is understood that the laser source may also be located separately from the scanning head, in which case guidance of the laser beam to the scanning head may be furnished, for instance by means of glass fibers.

The workpiece 200 is part of workpieces to be joined together that are fixed by a fastening mechanism 103 and arranged for the welding operation.

The system 100 furthermore has a schematically indicated MPS control 104. The control 104 is connected to the scanning head 102 via a sketched-in connection 105a, to the six-axis industrial robot via a sketched-in connection 105b, and to the fastening mechanism 103 via a sketched-in connection 105c. The connections 105a-105c are typically embedded in cables, as is customary for one skilled in the art.

The MPS control 104 is also connected via a connection 106 to a computer 107.

The computer 107 is provided for the time-critical functions of the system 100, in particular for the programming of the MPS control 104 and the observation and user control of the welding operation.

In the embodiment shown of the system 100, the six-axis industrial robot 101, the scanning head 102 (laser beam power output and laser beam positioning) and the fastening mechanism 103 are controlled or regulated by the MPS control 104. To that end, first the fastening mechanism 103 is controlled or regulated by the MPS control 104 in such a manner that the workpiece 200 to be welded is fixedly fastened in place and located as intended. Next, the six-axis industrial robot 101 is controlled or regulated by the MPS control 104 in such a way that the scanning head 102 is located as intended above the workpiece 200.

The arrangement by means of the six-axis industrial robot 101 is equivalent to a coarse arrangement. Next, the scanning mirrors (not shown) in the scanning head 102 are controlled or regulated by the MPS control 104 in such a way that the laser beam is aimed at the intended welding spot. Finally, the laser beam power is controlled or regulated by the MPS control 104 in such a way that the desired welding power is furnished within a desired period of time.

The functions just named are time-critical functions, whose real-time capability can be assured by the control by means of the MPS control 104.

In FIG. 2, a second preferred embodiment of a laser body shell welding system (hereinafter called “system”) of the invention is shown schematically and identified overall by the reference numeral 110. Elements identical to those in FIG. 1 are provided with the same reference numerals. Hereinafter only the differences from the system 100 of FIG. 1 will be explained. Otherwise, the operation and control of the system 110 is effected analogously to the system 100.

The system 110 likewise has the machine arm embodied as the six-axis industrial robot 101. In contrast to FIG. 1, however, in the system 110 the scanning head 102 is operated as an external tool of the machine arm 101. For that purpose, the scanning head 102 is located in a stationary fashion. The workpieces 200 to be welded are fastened by means of the fastening mechanism 103 located on the six-axis industrial robot 101 and are positioned coarsely relative to the scanning head 102 by the six-axis industrial robot 101. The control of the machine arm 101, the scanning head 102 (scanning mirrors, laser power), and the fastening mechanism 103 is effected by the MPS control 104.

It is understood that in the drawings shown, only especially preferred embodiments of the laser body shell welding system of the invention are shown. Still other embodiments are conceivable without departing from the scope of the present invention.

It will be understood that each of the elements described above, or two or more together, may also find a useful application in other types of constructions differing from the type described above.

While the invention has been illustrated and described as embodied in a method for controlling a laser body shell welding system, and laser body shell welding system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method for controlling a laser body shell welding system, in which a scanning head is attached to a machine arm or is operated as an external tool of the machine arm, the scanning head having at least one scanning mirror for positioning a laser beam on a workpiece to be welded, and an operation of the laser welding system includes time-critical functions, the method comprising the steps of controlling the time-critical functions; and using for the controlling of the time-critical functions a system selected from the group consisting of an embedded control system, and a memory-programmable control system.

2. A method as defined in claim 1, wherein said controlling the time-critical functions includes controlling at least one scanning mirror as the time-critical function.

3. A method as defined in claim 1, wherein said controlling the time-critical functions includes controlling a power output of the laser beam as the time-critical function.

4. A method as defined in claim 1, wherein said controlling the time critical functions includes controlling a fastening mechanism as the time-critical function.

5. A method as defined in claim 1, wherein said controlling the time-critical function includes controlling the machine arm as the time-critical function.

6. A method as defined in claim 1, wherein said controlling the time-critical functions includes controlling an observation/reconstruction of a motion of the machine arm implemented as the time-critical function.

7. A laser body shell welding system, comprising a scanning head attached to a machine arm or operated as an external tool of the machine arm, said scanning head including at least one scanning mirror for positioning a laser beam on a workpiece to be welded, wherein an operation of the laser welding system includes time-critical functions; and means for controlling the time-critical functions selected from the group consisting of an embedded control system and a memory-programmable control system.

8. A laser body as defined in claim 7, wherein said controlling means is configured for controlling at least one scanning mirror as the time-critical function.

9. A laser body as defined in claim 7, wherein said controlling means is configured for controlling a power output of the laser beam as the time-critical function.

10. A laser body as defined in claim 7, wherein said controlling means is configured for controlling a fastening mechanism as the time-critical function.

11. A laser body as defined in claim 7, wherein said controlling means is configured for controlling the machine arm as the time-critical function.

12. A laser body as defined in claim 7, wherein said controlling means is configured for controlling an observation/reconstruction of a motion of the machine arm as the time-critical function.
